(19) United States
(12) Patent Application Publication
(10) Pub. No.: US 2004/0001616 A1
(43) Pub. Date: Jan. 1, 2004

(54) Measurement of content ratings through vision and speech recognition

(76) Inventors: Srinivas Gutta, Yorktown Heights, NY (US); Antonio Colmenarez JR., Maracaibo (VE); Miroslav Trajkovic, Ossining, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/183,759

(22) Filed: Jun. 27, 2002

(51) Int. Cl. G06K 9/00

(52) U.S. Cl. 382/118

(57) ABSTRACT

A method for measuring customer satisfaction with at least one of a service, product, and content is provided. The method including: acquiring at least one of image and speech data for the customer; analyzing the acquired at least one of image and speech data for at least one of the following: (a) detection of a gaze of the customer; (b) detection of a facial expression of the customer; (c) detection of an emotion of the customer; (d) detection of a speech of the customer; and (e) detection of an interaction of the customer with at least one of the service, product, and content; and determining customer satisfaction based on at least one of (a)-(e).

### BACKGROUND OF THE INVENTION

1. Field of the Invention

The present invention relates generally to vision and speech recognition, and more particularly, to methods and devices for measuring customer satisfaction through vision and/or speech recognition.

2. Prior Art

In the prior art there are known several ways to assess an interest in a displayed product, service, or content (collectively referred to herein as “product”) by a customer. However, all of the known ways are manually carried out. For instance, questionnaire cards may be available near the product for passersby to take and fill-out. Alternatively, a store clerk or sales representative may solicit a customer's interest in the product by asking them a series of questions relating to the product. However, in either way, the persons must willingly participate in the questioning. If willing, the manual questioning takes time to complete, often much more time than people are willing to spend. Furthermore, the manual questioning depends on the truthfulness of the people participating. For content, such as television programming, one service, Nielson, automatically measures what content is currently being watched and by whom. However, they do not measure if the individual liked or disliked the content automatically.

Additionally, manufacturers and vendors of the displayed products often want information that they'd rather not reveal to the participants, such as characteristics like gender and ethnicity. This type of information can be very useful to manufacturers and vendors in marketing their products. However, because the manufacturers perceive the participants as not wanting to supply such information or be offended by such questioning, the manufacturers and vendors do not ask such questions on their product questionnaires.

### SUMMARY OF THE INVENTION

Therefore it is an object of the present invention to provide methods and apparatus for automatically measuring a customer's satisfaction of a product, service, or content.

Accordingly, a method for measuring customer satisfaction with at least one of a service, product, and content is provided. The method comprising: acquiring at least one of image and speech data for the customer; analyzing the acquired at least one of image and speech data for at least one of the following: (a) detection of a gaze of the customer; (b) detection of a facial expression of the customer; (c) detection of an emotion of the customer; (d) detection of a speech of the customer; and (e) detection of an interaction of the customer with at least one of the service, product, and content; and determining customer satisfaction based on at least one of (a)-(e).

Preferably, the method further comprises determining at least one of a gender, ethnicity, and age of the customer from the at least one of image and speech data.

The acquiring preferably comprises identifying the customer in the image data. The identifying preferably comprises detecting a face in the image data. Alternatively, the identifying comprises classifying objects in the image data as people and non-people.

The detection of a gaze of the customer preferably comprises at least one of determining if a direction of the detected gaze is towards at least one of the service, product, and content and the duration of the gaze towards at least one of the service, product, and content.

Preferably, the detection of a facial expression of the customer comprises determining whether the detected facial expression is one of satisfaction or dissatisfaction.

The method preferably further comprises detecting whether the gaze of the customer is towards at least one of the service, product, and content at a time when the facial expression is detected and wherein the determining of the customer satisfaction is at least partly based thereon.

Preferably, the detection of an emotion of the customer is at least partly based on the detection of at least one of the speech and facial expression of the customer.

The detection of an emotion of the customer preferably comprises detecting an intensity of the emotion of the customer.

Preferably, the detecting of an intensity of emotion is at least partly based on the detection of at least one of the speech and facial expression of the customer.

The detecting of a speech of the customer preferably comprises detecting specific phrases of the recognized speech.

Preferably, the detecting of a speech of the customer comprises detecting emotion in the recognized speech.

The detection of an interaction of the customer with at least one of the service, product, and content preferably comprises detecting a physical interaction with at least one of the product, service, and content.

Also provided is an apparatus for measuring customer satisfaction with at least one of a service, product, and content. The apparatus comprising: at least one of a camera and microphone for acquiring at least one of image and speech data for the customer; and a processor having means for analyzing the acquired at least one of image and speech data for at least one of the following: (a) detection of a gaze of the customer; (b) detection of a facial expression of the customer; (c) detection of an emotion of the customer; (d) detection of a speech of the customer; and (e) detection of an interaction of the customer with at least one of the service, product, and content; wherein the processor further has means for determining customer satisfaction based on at least one of (a)-(e).

Preferably, the processor further has means for determining at least one of a gender, ethnicity, and age of the customer from the at least one of image and speech data.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates schematic of a preferred implementation of an apparatus for carrying out the methods of the present invention.

FIGS. 2a and 2b illustrate a flowchart showing a preferred implementation of a method of the present invention.

### DETAILED DESCRIPTION OF THE PREFERRED EMBODIMENT

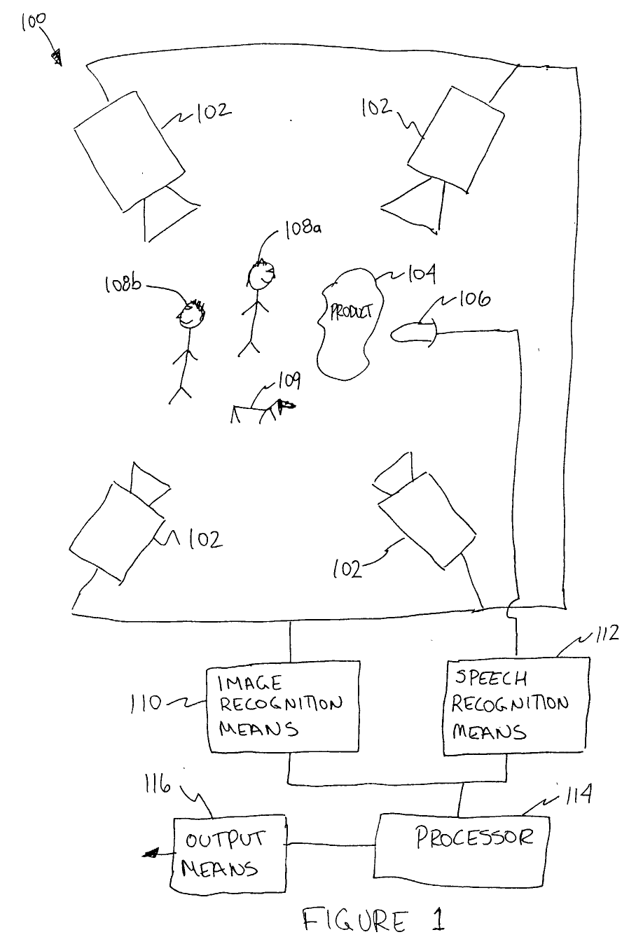

Referring now to FIG. 1, there is shown an apparatus for measuring customer satisfaction with at least one of a service, product, and content, the apparatus being generally referred to by reference numeral 100. Apparatus 100 includes at least one, and preferably several cameras 102 having a field of view sufficient to capture image data within a predetermined area of a displayed product, service, or content 104. The term camera is used in its generic sense to mean all image capturing devices. The cameras 102 are preferably digital video cameras, however, they also may be analog video cameras, digital still image cameras and the like. If an analog camera is used, its output must be appropriately converted to a digital format. The cameras 102 can be fixed or have a pan, tilt, and zoom capability. The apparatus also includes at least one microphone 106 for capturing speech data from the predetermined area. The microphone 106 is preferably a digital microphone, however, other types of microphones can also be utilized if the output signal thereof is appropriately converted to a digital format. The term microphone is used in its generic sense to mean all sound capturing devices.

The cameras 102 and microphone 106 are useful in acquiring image and speech data for a customer 108a, 108b or other objects 109 within the predetermined area. Although, either a microphone 106 or at least one camera 102 is necessary for practicing the methods of the present invention, it is preferred that both are utilized. As used herein, the term “customer” refers to any person detected in the image and/or speech data within the field of view/sound of the cameras 102 and microphone 106. The customer may or may not be interested in the displayed products, services, and/or content, his or her presence in the predetermined area is cause enough to be classified as a “customer”.

The captured image and speech data is analyzed by respective image and speech recognition means 110, 112, respectively in a manner to be discussed below. Apparatus 100 also includes a processor 114, such as a personal computer. The image and speech recognition means 110, 112, although shown in FIG. 1 as separate modules, are preferably implemented in the processor 114 to carry out a set of instructions which analyze the input image and speech data from the cameras 102 and microphone 106. Preferably, the processor 114 further has means for determining at least one of a gender, ethnicity, and age of the customer 108a, 108b from the captured image and/or speech data. The apparatus 100 also includes an output means 116 for outputting a result of the analysis by the processor 114. The output means 116 can be a printer, monitor, or an electronic signal for use in a further method or apparatus.

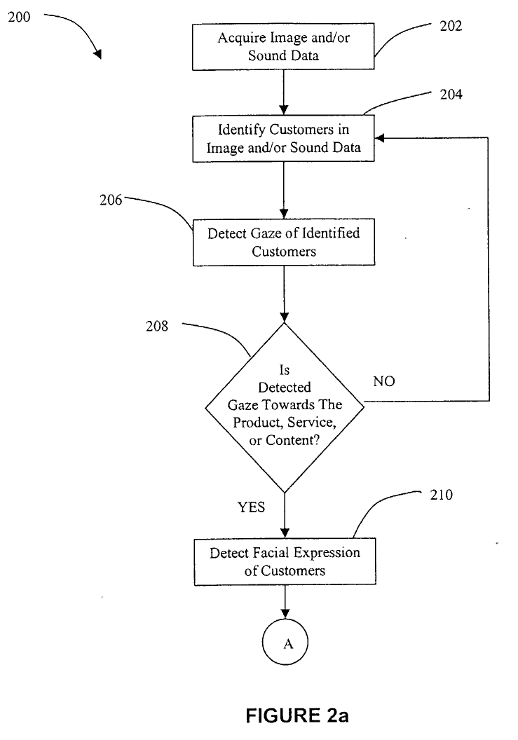

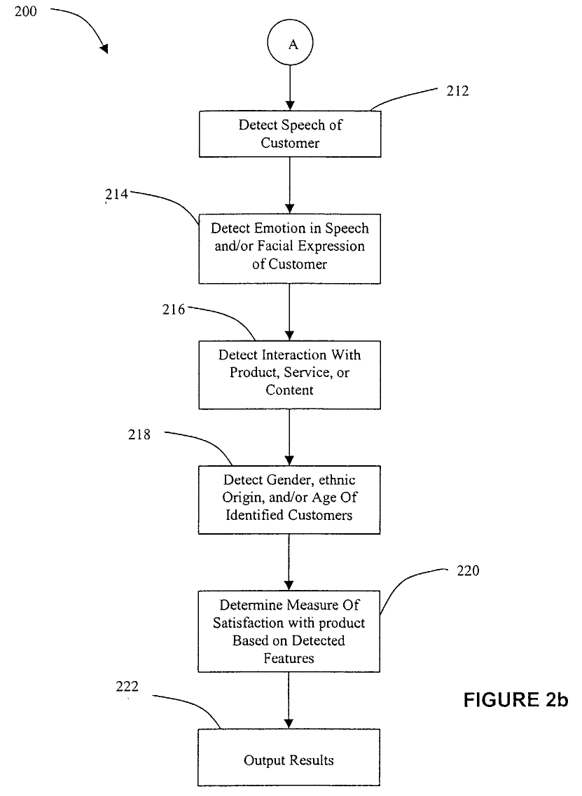

A preferred implementation of a method of the present invention will now be described with regard to FIGS. 2a and 2b. FIGS. 2a and 2b illustrate a flowchart showing a preferred implementation of a method to be preferably carried out by apparatus 100, the method being generally referred to by reference numeral 200. The method 200 measures customer satisfaction with at least one of a service, product, and content (collectively referred to herein as a “product”). The product can be displayed in a public area, such as a shopping area in which the product (e.g., a consumer product) is displayed within the predetermined area or in a private area in which the product (e.g., content such as a television program) is being viewed within the predetermined area.

At step 202, at least one, and preferably both, of image and speech data are acquired for the predetermined area by the cameras 102 and/or microphone 106. After acquisition of the image and/or speech data, the customer(s) 108a, 108b are identified in the image and/or speech data at step 204. Although, either or both of the image and speech data can be utilized to identify the cutomer(s) in the predetermined area, it is preferred that the image data is so utilized using any method known in the art for recognizing humans in image data.

One such method is where faces are detected in the image data and each face is associated with a person. Once a face is found then it can be safely assumed that a human being exists. An example of the recognition of people in image data by the detection of faces is disclosed in Gutta et al., Mixture of Experts for Classification of Gender, ethnic Origin, and Pose of Human Faces, IEEE Transactions on Neural Networks, Vol. 11, No. 4, July 200.

Another method is to classify objects in the image data as people and non-people. For instance, the people 108a, 108b in FIG. 1 would be classified as customers while the dog 109 would be classified as a non-human and discarded for purposes of the analysis. An example of such a system is disclosed co-pending U.S. patent application Ser. No. 09/794,443, to Gutta et al., entitled Classification of Objects through Model Ensembles, Filed Feb. 27, 2001.

Once it is determined that a human being exists, other features may be determined like, gender, ethnic origin, facial pose, facial expressions, etc. As discussed below, these features may be used in determining a measure of the customer's interest in a displayed product. Methods for estimating a person's gender and ethnic origin are well known in the art, such as that disclosed in Gutta et al., Mixture of Experts for Classification of Gender, ethnic Origin, and Pose of Human Faces, IEEE Transactions on Neural Networks, Vol. 11, No. 4, July 200.

Examples of some of the features that can be determined by an analysis of the image and/or speech data are: detection of a gaze of the customer 108a, 108b; detection of a facial expression of the customer 108a, 108b; detection of an emotion of the customer 108a, 108b; detection of a speech of the customer 108a, 108b; and detection of an interaction of the customer 108a, 108b with the product, one or more of which may be utilized to measure a customer's interest/satisfaction in a product.

With regard to the detection of a gaze of the customer(s) 108a, 108b, such is preferably carried out at step 206. At step 208 it is preferably determined whether the detected gaze is towards the product 104. For instance, customer 108a in FIG. 1 would be classified as having a gaze towards the product 104, while customer 108b would be classified as having a gaze away from the product 104. If a detected customer 208b is found to have a gaze away from the product 104, the method 200 proceeds along path 208-NO and the customer 208b is not used in the analysis except for his or her apparent non-interest in the product 104 and the method loops back to step 204 where customers continue to be identified in the image data. If a customer 108a is found to have a gaze towards the product 104, the method continues along path 208-YES where other features are detected for that customer 108a.

Along with the direction of the gaze, the duration of the gaze, particularly the duration of the gaze towards the product can also be detected from the image data. It can be assumed that duration of gaze towards the product is indicative of interest in the product. Methods for detecting gaze in image data are well known in the art, such as that disclosed in Rickert et al., Gaze Estimation using Morphable Models, Proceedings of the Third International Conference on Automatic Face and Gesture Recognition, Nara, Japan, Apr. 14-16, 1998.

With regard to the detection of a facial expression of the customer, such is preferably carried out at step 210 only for those customers 108a that are found to be gazing towards the product 104. Preferably, the detection of a facial expression of the customer 108a comprises determining whether the detected facial expression is one of satisfaction or dissatisfaction. For instance, the detection of a smile or excited look would indicate satisfaction, while the detection of a frown or perplexed look would indicate dissatisfaction. Methods for detecting facial expressions are well known in the art, such as that disclosed in Colmenarez et al., Modeling the Dynamics of Facial Expressions, CUES Workshop held in conjunction with the International Conference on Computer Vision and Pattern Recognition, Hawaii, USA, Dec. 10-15, 2001.

With regard to the detection of speech, such is preferably carried out at step 212 and can be useful for not only identifying the customers 108a, 108b in the predetermined area but also in determining a measure of their satisfaction with the product. For instance, the detecting of a speech of the customer 108a, 108b can detect specific phrases in the recognized speech. For instance, the recognition of terms “that's great” or “cool” would indicate a measure of satisfaction while the terms “stinks” or “terrible” would indicate a measure of dissatisfaction.

At step 214, the emotion of a detected customer 108a, 108b can be detected. Since customer 108a is gazing at the product, only his or her emotion would be detected. The detection of an emotion of the customer 108a is preferably based on (at least in part) the detection of the speech and/or facial expression of the customer 108a. Furthermore, an intensity of a detected emotion can also be detected. For instance, certain facial expressions, such as an excited look, have a greater emotional intensity than a smile. Similarly, an intensity of emotion can also be detected in the detected speech of the customer 108a, such as where the customer changes his speech pattern (e.g., speaks faster or louder) or uses expletives. Recognition of emotion in facial expressions and speech are well known in the art, such as that disclosed in Colmenarez et al., Modeling the Dynamics of Facial Expressions, CUES Workshop held in conjunction with the International Conference on Computer Vision and Pattern Recognition, Hawaii, USA, Dec. 10-15, 2001; and Frank Dellaert et al., Recognizing Emotion in Speech, in Proc. of Int'l Conf. on Speech and Language Processing (1996); and Polzin et al., Detecting Emotions in Speech, Proceedings of the Cooperative Multimodal Communication Conference, 1998.

At step 216, it is determined whether there is an interaction of the customer 108a with the product 104, such as a physical interaction with at the product. For instance, with regard to a product which is displayed (e.g., an automobile) a determination that the customer 108a touched the product and possibly played with certain switches or other portions of the product can indicate a measure of satisfaction with the product, particularly when coupled with the detection of a favorable emotion, speech, and/or facial expression. A determination of physical interaction can be made by analyzing the image data from the cameras 102 and/or from feedback from tactile sensors (not shown). Such methods for determining a physical interaction with products are well known in the art.

As discussed above, the detection of other features such as gender, ethic origin, and age of the customer 108a, 108b may also be made, preferably at step 218. Although, such features may not be useful in determining a measure of satisfaction with a product, it can be very useful in terms of marketing. For instance, the method 200 can determine that most women are satisfied with a particular product, while most men are either dissatisfied or not interested with the product. Similar marketing strategies may be learned from an analysis of satisfaction and ethnic origin and/or age.

At step 220, customer satisfaction is determined based on at least one of the above-discussed features, and preferably a combination of such features. A simple algorithm for such a determination would be to assign weights to each of the features and calculate a score therefrom which indicates a measure of satisfaction/dissatisfaction. That is, a score that is less than a predetermined number would indicate a dissatisfaction while a score above the predetermined number would indicate a satisfaction with the product 104. Another example would be to assign a point for each feature where a possible satisfaction is indicated, where a cumulative score of the points for all of the features detected over a predetermined number would indicate a satisfaction while a cumulative score below the predetermined number would indicate a dissatisfaction with the product 104. The algorithm may also be complicated and provide for a great number of scenarios and combinations of the detected features. For instance, as discussed above, a customer 108a who is detected to be gazing at the product 104 for a long duration of time and whom there is detected a high intensity of emotion in his or her speech and facial expressions would indicate a great satisfaction with the product while a customer 108a who looks at a product with a dissatisfied facial expression and a dissatisfied emotion in his or her speech would indicate little or no interest in the product. Similarly, a customer 108a who only glances at a product 104 for a short tome and has little or no emotion in his or her speech and facial expression may indicate little or no interest in the product 104.

At step 222, the results of the analysis are output for review, statistical analysis, or use in another method or apparatus.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for measuring customer satisfaction with at least one of a service, product, and content, the method comprising:
acquiring at least one of image and speech data for the customer;
analyzing the acquired at least one of image and speech data for at least one of the following:
(a) detection of a gaze of the customer;
(b) detection of a facial expression of the customer;
(c) detection of an emotion of the customer;
(d) detection of a speech of the customer; and
(e) detection of an interaction of the customer with at least one of the service, product, and content; and
determining customer satisfaction based on at least one of (a)-(e).

2. The method of claim 1, further comprising determining at least one of a gender, ethnicity, and age of the customer from the at least one of image and speech data.

3. The method of claim 1, wherein the acquiring comprises identifying the customer in the image data.

4. The method of claim 3, wherein the identifying comprises detecting a face in the image data.

5. The method of claim 3, wherein the identifying comprises classifying objects in the image data as people and non-people.

6. The method of claim 1, wherein the detection of a gaze of the customer comprises at least one of determining if a direction of the detected gaze is towards at least one of the service, product, and content and the duration of the gaze towards at least one of the service, product, and content.

7. The method of claim 1, wherein the detection of a facial expression of the customer comprises determining whether the detected facial expression is one of satisfaction or dissatisfaction.

8. The method of claim 6, further comprising detecting whether the gaze of the customer is towards at least one of the service, product, and content at a time when the facial expression is detected and wherein the determining of the customer satisfaction is at least partly based thereon.

9. The method of claim 1, wherein the detection of an emotion of the customer is at least partly based on the detection of at least one of the speech and facial expression of the customer.

10. The method of claim 1, wherein the detection of an emotion of the customer comprises detecting an intensity of the emotion of the customer.

11. The method of claim 10, wherein the detecting of an intensity of emotion is at least partly based on the detection of at least one of the speech and facial expression of the customer.

12. The method of claim 1, wherein the detecting of a speech of the customer comprises detecting specific phrases of the recognized speech.

13. The method of claim 1, wherein the detecting of a speech of the customer comprises detecting emotion in the recognized speech.

14. The method of claim 1, wherein the detection of an interaction of the customer with at least one of the service, product, and content comprises detecting a physical interaction with at least one of the product, service, and content.

15. A computer program product embodied in a computer-readable medium for measuring customer satisfaction with at least one of a service, product, and content, the computer program product comprising:
computer readable program code means for acquiring at least one of image and speech data for the customer;
computer readable program code means for analyzing the acquired at least one of image and speech data for at least one of the following:
(a) detection of a gaze of the customer;
(b) detection of a facial expression of the customer;
(c) detection of an emotion of the customer;
(d) detection of a speech of the customer; and
(e) detection of an interaction of the customer with at least one of the service, product, and content; and
computer readable program code means for determining customer satisfaction based on at least one of (a)-(e).

16. The computer program product of claim 15, further comprising computer readable program code means for determining at least one of a gender, ethnicity, and age of the customer from the at least one of image and speech data.

17. A program storage device readable by machine, tangibly embodying a program of instructions executable by the machine to perform method steps for measuring customer satisfaction with at least one of a service, product, and content, the method comprising:
acquiring at least one of image and speech data for the customer;
analyzing the acquired at least one of image and speech data for at least one of the following:
(a) detection of a gaze of the customer;
(b) detection of a facial expression of the customer;
(c) detection of an emotion of the customer;
(d) detection of a speech of the customer; and
(e) detection of an interaction of the customer with at least one of the service, product, and content; and
determining customer satisfaction based on at least one of (a)-(e).

18. The program storage device of claim 17, wherein the method further comprises determining at least one of a gender, ethnicity, and age of the customer from the at least one of image and speech data.

19. An apparatus for measuring customer satisfaction with at least one of a service, product, and content, the apparatus comprising:
at least one of a camera and microphone for acquiring at least one of image and speech data for the customer; and
a processor having means for analyzing the acquired at least one of image and speech data for at least one of the following:
(a) detection of a gaze of the customer;
(b) detection of a facial expression of the customer;
(c) detection of an emotion of the customer;
(d) detection of a speech of the customer; and
(e) detection of an interaction of the customer with at least one of the service, product, and content;
wherein the processor further has means for determining customer satisfaction based on at least one of (a)-(e).

20. The apparatus of claim 19, wherein the processor further has means for determining at least one of a gender, ethnicity, and age of the customer from the at least one of image and speech data.
